(19) United States
(12) Patent Application Publication
(10) Pub. No.: US 2010/0188229 A1
(43) Pub. Date: Jul. 29, 2010

(54) Safety shut off system for household appliances

(76) Inventor: Nhean Nhep, Richmond, VA (US)

Correspondence Address: THE INVENTORS NETWORK, INC., 332 ACADEMY STREET, CARNEGIE, PA, 15106, US

(21) Appl. No.: 12/321,703

(22) Filed: Jan. 26, 2009

(51) Int. Cl. G08B 23/00; G08B 21/00

(52) U.S. Cl. 340/573.1; 340/638; 340/527

(57) ABSTRACT

A safety shut off system incorporated into the electrical circuitry of the house for shutting off an appliance after a predetermined time period elapses within which no physical movement within the vicinity of the appliance is detected includes a motion sensor interconnected to the breaker controlling the appliance whereupon the motion sensor signals the breaker to trip after the time period elapses in which no movement is detected, a contactor that allows current flow between the motion sensor and the breaker, and a relay interconnected to the appliance fan and light and the breaker whereupon turning on the appliance automatically actuates the fan and light but when the breaker is tripped for shutting off the appliance the relay is actuated to shut off the fan and light.

### FIELD OF THE INVENTION

The present invention pertains to motion activated home safety systems, and more particularly pertains to a household safety system responsive to motion, or a lack thereof, for initiating the shutting off of a household appliance.

### BACKGROUND OF THE INVENTION

Automatic shut off mechanisms have a variety of applications ranging from the operation and control of power tools and lawn mowers to computers and automotive vehicles. Household items and health and beauty products such as hair dryers, curling irons, and cloth pressing irons also come equipped with some type of automatic shut off mechanism that turns the item off after a predetermined time period of non-use elapses.

Such shut off features serve several critical purposes, most importantly, saving energy and safety. Many home fires are caused by an item, such as an iron or range, inadvertently left on while the residents leave the room or leave the house to run errands or go shopping only to return and find that a major house fire has occurred because some household item was not turned off. This is especially critical as the number of elderly and handicapped individuals choosing to live independent and alone has climbed in recent years, and even though cell phone and Internet technology has proliferated, assistance in such an emergency as a house fire may arrive to late for the individual. Elderly and handicapped individuals do not have the quick reactions and mobility, and are often forgetful, which increases the danger of a house fire inadvertently sparked by a household item or appliance that was turned on and then forgotten. Thus, it is desirable to have a safety shut off system incorporated into the electrical circuitry of the house that automatically shuts off items, such as household appliances, that, if left on, could cause a major house fire and injury or even death to the resident(s) of the household. The prior art shows numerous automatic shut off systems for a variety of applications.

For example, the Doyle et al. patent (U.S. Pat. No. 4,595,894) discloses a switching apparatus for selectively interrupting an electrical connection between input and output conductors.

The Albinger, Jr. et al. patent (U.S. Pat. No. 4,745,260) discloses an automatic switching apparatus for an electric appliance that includes a motion sensor and an electric timer that cooperate to automatically shut off the iron if the iron remains stationary for a predetermined time period.

The Van Marcke patent (U.S. Pat. No. 5,217,035) discloses a system for automatic control of public washroom fixtures that automatically controls water valves and soap valves by infrared sensing of the user's hands.

The Higley patent (U.S. Pat. No. 5,628,242) discloses an automatic shut off for a gas cooker or grill that monitors activity with a motion detector that shuts off the grill when no activity has been detected for a predetermined time period.

The Uhler patent (U.S. Pat. No. 6,860,288 B2) discloses a system and method for monitoring and controlling utility systems that is interconnected to the utility system main supply line.

Nonetheless, despite the ingenuity of the aforedescribed devices, there remains a need for a reliable safety shut off system for a household appliance that is easy to install, inexpensive, accurate, and provides an added measure of safety for individuals living alone, especially the elderly and handicapped individuals.

### SUMMARY OF THE INVENTION

The present invention comprehends a safety shut off system for household appliances that automatically shuts off the appliance to which it is interconnected after a predetermined time period has elapsed in which no activity in the vicinity of the appliance has been detected. The safety shut off system can be interconnected to the electrical circuitry of the dwelling, and specifically the circuit breaker for the appliance, primarily a household stove or range. Most significantly, the safety shut off system doesn't interfere with the household wiring and circuitry, but is incorporated with it. One further advantage of this system is that it will automatically turn on the stove or range exhaust fan when the stove or range is turned on.

The safety shut off system includes a motion sensor mounted adjacent to the appliance and in a location where a wide field of motion can be detected. Mounting the motion sensor directly in front of or above the appliance will not provide a wide enough field of motion detection and would prematurely trigger the safety system to shut off the appliance. After a predetermined time period within which motion hasn't been detected within the detection range, the motion sensor trips the breaker which then automatically shuts off the appliance. Also incorporated into the electrical circuitry is a contactor that permits current to pass within the circuit and between the motion sensor and the breaker, and a relay that is actuated to turn on the fan and light, and, upon the breaker being tripped by lack of movement the relay is actuated (disposed to the open state) thereby shutting off the fan and light. If desired a bypass switch can be incorporated into the electrical circuitry to bypass the motion sensor; but when the bypass switch is turned off the safety system is thus engaged.

It is an objective of the present invention to provide a safety shut off system for household appliances that can be installed onto any household appliances.

It is another objective of the present invention to provide a safety shut off system for household appliances that provides essential safety for elderly or handicapped individuals living alone and independent.

It is yet another objective of the present invention to provide a safety shut off system for household appliances that protects the individual from accidentally leaving an appliance on, thus preventing a fire and serious injury or death to the individual.

It still yet another objective of the present invention to provide a safety shut off system for household appliances that can easily be installed and protects a forgetful elderly individual so that individual can live in a protected, yet independent, environment.

Still another objective of the present invention is to provide a safety shut off system for household appliances that relieves the individual, especially a handicapped or elderly individual, of worrying whether an appliance was left on or turned off.

Still yet another objective of the present invention is to provide a safety shut off system for household appliances that also includes the ability to turn on the exhaust fan when the stove is turned on.

These and other objects, features, and advantages will become apparent to those skilled in the art upon a perusal of the following detailed description read in conjunction with the accompanying drawings and appended claims.

### BRIEF DESCRIPTION OF THE DRAWINGS

FIG. 1 is a perspective view of the safety shut off system of the present invention illustrating several of the primary structural elements of the system;

FIG. 2 is a top plan view of the safety shut off system of the present invention illustrating the disposition of the motion sensor relative to the appliance for providing a wide range of motion detection or non-detection in the vicinity of the appliance;

FIG. 3 is a perspective view of the safety shut off system of the present invention illustrating the motion sensor;

FIG. 4 is a representative flowchart for the safety shut off system of the present invention illustrating the various steps undertaken by the system when activated for motion detection; and

FIG. 5 is a representative electrical schematic of the safety shut off system of the present invention.

### DETAILED DESCRIPTION OF THE PREFERRED EMBODIMENTS

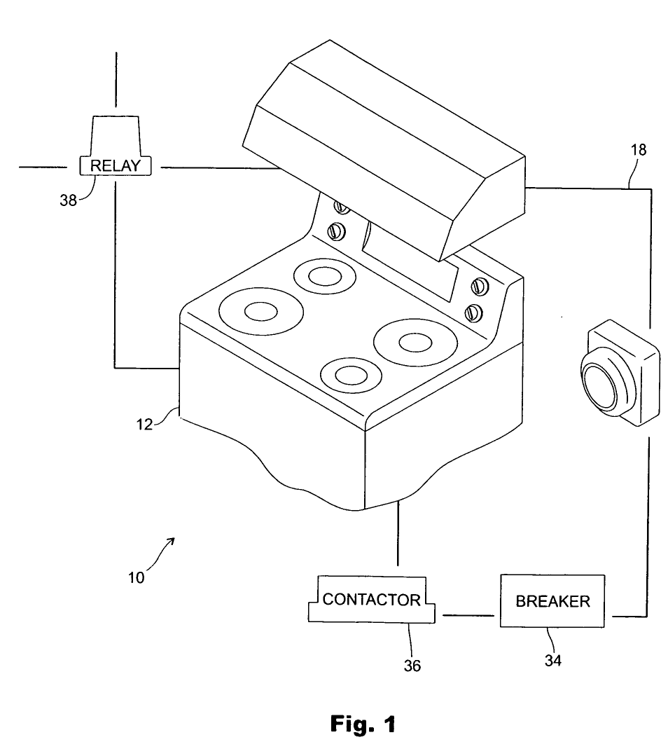

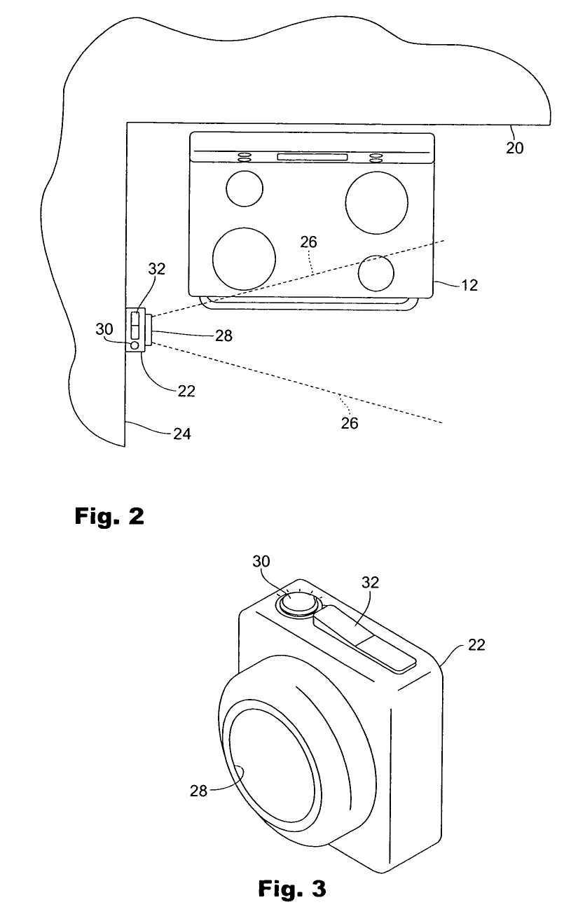

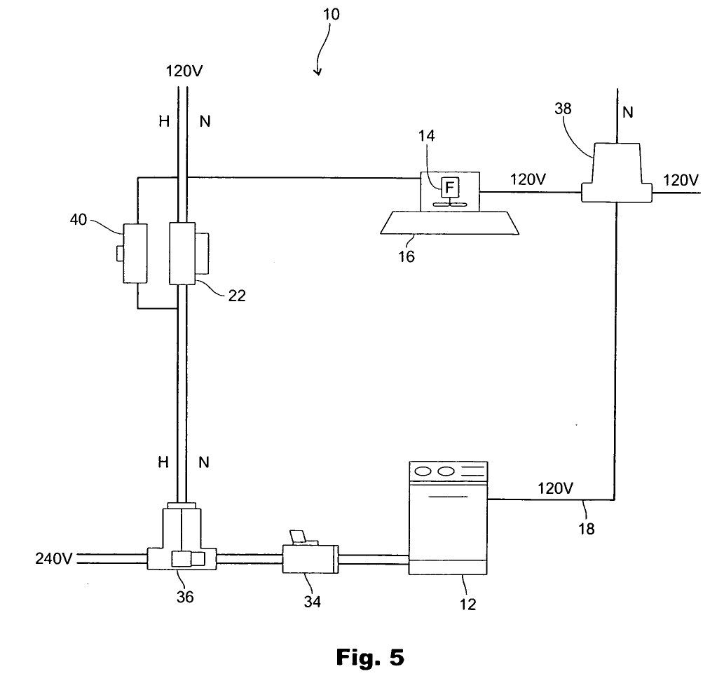

Illustrated in FIGS. 1-5 is a safety shut off system 10 for household appliances that automatically shuts off an appliance within a fixed, uninterrupted, and predetermined time period if no motion or movement in the vicinity of the appliance has been detected or sensed. The appliance can be a washer, dryer, dishwasher, stove or range, and is most particularly useful with a range or stove 12 as shown in FIG. 2. The stove 12 shown in FIGS. 1 and 5 includes an overhead exhaust fan 14 and light 16 also electrically interconnected to the house wiring and electrical circuitry 18. Given that many elderly and handicapped individuals want to maintain their independence by living alone, leaving the stove 12 turned on or not being able to get to the stove 12 to turn it off upon seeing smoke and flames emanating from the kitchen can easily and quickly become a life-threatening event. Also given that many elderly people are forgetful about leaving an appliance, such as the stove 12 on, this is a primary safety risk and always a concern to the family of the elderly and independent living individual.

Thus, as shown in FIGS. 1-3, the stove 12 is placed against one wall 20 of the kitchen and a motion sensor 22 is mounted to an adjacent wall 24 with the motion sensor range or cone 26 defined by the broken lines that extend outward in a triangular shape from the motion sensor 22. The motion sensor 22 includes a lens 28, a lens adjustment button 30 and a manual reset switch 32. Turning the lens adjustment button 30 varies the aperture size so that the motion sensor range or cone 26 can be reduced or enlarged. The motion sensor 26 can be optical or utilizes infrared radiation. If the motion sensor cone 26 is too small, the safety shut off system 10 is triggered too soon so that movement even a few feet away from the stove 12 would be outside the cone 26 and such absence after a predetermined time period would actuate the shutting off of the stove 12; while if the motion sensor cone 26 is too large movement in another room would still register as movement in the kitchen and would prevent automatic stove 12 shut down within a reasonable time period. The motion sensor 22 can be mounted to the adjacent wall 24 by any conventional means such as brackets or wall hangers.

As shown in FIG. 1, the system 10 is designed to be incorporated and integrated with the electrical wiring and circuitry 18 of the dwelling. Thus, the motion sensor 22 is electrically interconnected to the appropriate breaker 34 that controls house current (generally 240 volt) to the stove 12, and a contactor 36 that allows current to flow through the circuit 18 and between the breaker 34 and the stove 12. In addition, a relay 38 is placed in the circuit 18 for actuating the turning on of the fan 14 and light 16, and also for actuating the turning off of the fan 14 and light 16 concomitant with the shutting off of the stove 12. As illustrated in FIG. 5, a bypass switch 40 can be added to the system 10 if, for example, the dwelling no longer has an elderly or handicapped individual as its sole or primary resident, and it is difficult if not cost prohibitive to remove the system 10. The bypass switch 40 allows the safety system 10 to be bypassed without physically removing the system 10 from the wiring and electrical circuitry 18 of the dwelling.

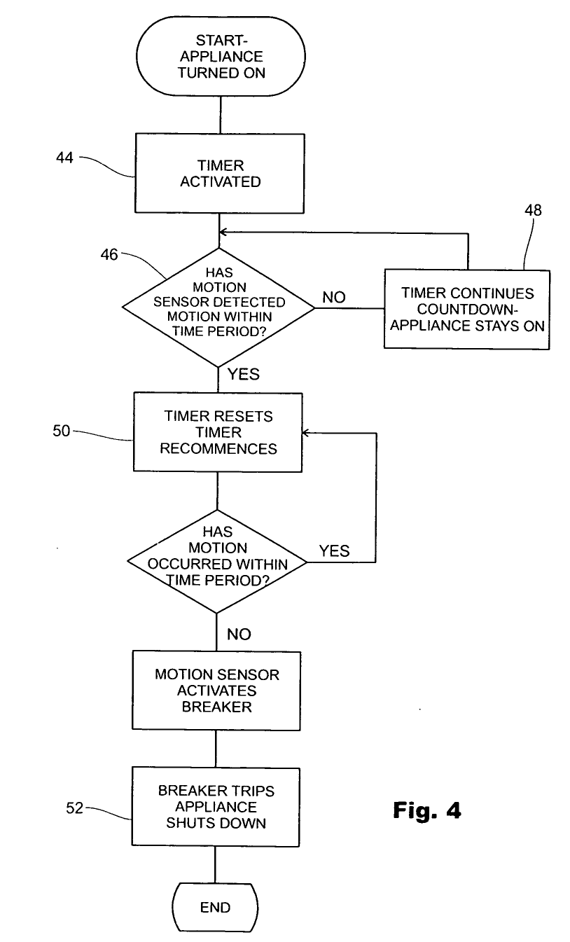

With reference to the flowchart of FIG. 4 and the electrical schematic of FIG. 5 the steps in the operation of the safety system 10 can be set forth. The first step would be for the individual to turn the stove on 42, and this action activates the timer 44 within the motion sensor 22 to begin counting down the predetermined fixed time period within which no motion or movement 46 within the motion sensor cone 26 and in the vicinity of the stove 12 is detected for actuating stove 12 shut off. The predetermined time period for detecting that the stove 12 is unattended can range from 15 minutes to 45 minutes. This range is selected because generally food cooked in modern gas or electric stoves, ovens, and ranges doesn't take longer than 45 minutes. With the timer 44 activated, the motion sensor 22 will continuously sense for motion within its detection range 26. If no physical movement or motion by any individual is detected and the predetermined time period for movement detection hasn't elapsed to actuate stove 12 shut off, the stove 12 stays on and the timer 44 continues its countdown as shown in the timer continues/appliance stays on block 48. However, if motion or movement is detected within the motion sensor range 26 within the predetermined time period, then the timer automatically resets itself and the countdown recommences and begins anew as illustrated by the time reset block 50.

On the other hand, if no motion or movement within the motion sensor range or cone 26 has occurred within the predetermined fixed time period, then the motion sensor 22 actuates the breaker to trip 52, and when the breaker 34 trips power (current) to the stove 12 is prevented thereby automatically shutting off the stove 12. As a result of the breaker 34 tripping the relay 38 is actuated and thereby shuts off power to the stove fan 14 and light 16 thus causing the stove fan 14 and light to turn off 16. After checking the stove 12 to make certain that no dangerous condition exists that requires further examination, the breaker 34 is reset so that current is allowed to pass through the contactor 36 to the stove 12 so that the stove 12 can again be turned on for use.

The invention has been described with reference to a preferred embodiment, and it is obvious that numerous modifications, alterations, and variations will occur to those skilled in the art, and it is thus intended that the invention should be construed to comprehend all contemplated modifications, alterations, variations, and changes in so far as they come with the scope of the appended claims and equivalents thereof as may be contemplated and conceived.

I claim:

1. A safety shut off system for automatically shutting off a household appliance after a time period elapses in which no movement is detected as occurring in the vicinity of the household appliance, the safety shut off system comprising:
a motion sensor mounted adjacent to the household appliance;
the motion sensor having a motion sensor cone within which physical movement adjacent to the household appliance is detected;
the motion sensor being electrically interconnected to a breaker that regulates electrical current to the household appliance;
a contactor that allows electrical current to pass between the breaker and the household appliance; and
whereupon turning on the household appliance activates the motion sensor so that if no physical movement is detected within the vicinity of the household appliance by the motion sensor as occurring within a fixed time period then the motion sensor actuates the breaker so that the breaker trips thereby automatically shutting off the household appliance.

2. The safety shut off system for a household appliance of claim 1 wherein the household appliance includes an exhaust fan and light.

3. The safety shut off system for a household appliance of claim 2 further comprising a relay electrically interconnected to the exhaust fan, light, and household appliance so that when the breaker trips to shut off the household appliance the relay is actuated thereby causing the exhaust fan and light to turn off.

4. The safety shut off system for a household appliance of claim 3 wherein the motion sensor optically detects for physical movement within the motion sensor cone.

5. The safety shut off system for a household appliance of claim 4 wherein the motion sensor detects for physical movement within the motion sensor cone by infrared radiation.

6. The safety shut off system for a household appliance of claim 5 further comprising a bypass switch that can be actuated so that the motion sensor is bypassed and automatic shut off of the household appliance will not occur.

7. The safety shut off system for a household appliance having an exhaust fan and light after a time period elapses in which no physical movement is detected as occurring within the vicinity of the household appliance, the safety shut off system comprising:
a motion sensor mounted adjacent to the household appliance;
the motion sensor having a motion sensor cone within which physical motion in the vicinity of the household appliance is detected;
the motion sensor being electrically interconnected to a breaker that regulates electrical current to the household appliance;
a contactor that allows electrical current to pass between the breaker and the household appliance;
a relay electrically interconnected to the exhaust fan, the light, and the household appliance; and
whereupon turning on the household appliance activates the motion sensor so that if no physical movement is detected as occurring within the vicinity of the household appliance by the motion sensor within a fixed time period then the motion sensor actuates the breaker so that the breaker trips and the relay actuates resulting in the turning off of the exhaust fan and light and the shutting off of the household appliance.

8. The safety shut off system for a household appliance of claim 7 further comprising a bypass switch that can be actuated so that the motion sensor is bypassed and the automatic shut off of the household appliance is prevented.

9. A safety shut off system for automatically shutting off a household appliance after a time period elapses in which no physical movement is detected as occurring in the vicinity of the household appliance, the safety shut off system comprising:
a motion sensor mounted adjacent to the household appliance;
the motion sensor having a motion sensor cone within which physical movement adjacent to the household appliance is detected;
the motion sensor being electrically interconnected to a breaker that regulates electrical current to the household appliance; and
whereupon turning on the household appliance activates the motion sensor so that if no physical movement is detected within the vicinity of the household appliance by the motion sensor as occurring within a fixed time period then the motion sensor actuates the breaker so that the breaker trips thereby automatically shutting off the household appliance.
